(19) United States
(12) Patent Application Publication
(10) Pub. No.: US 2025/0231547 A1
(43) Pub. Date: Jul. 17, 2025

(54) MODEL BASED DEVELOPMENT OF ZONE BASED FLOW OR THERMAL DISTRIBUTION SYSTEMS

(71) Applicant: Applied Materials, Inc., Santa Clara, CA (US)

(72) Inventors: DEVI RAGHAVEE VEERAPPAN, Nijmegen (NL); AJIT BALAKRISHNA, Santa Clara, CA (US)

(21) Appl. No.: 18/415,495

(22) Filed: Jan. 17, 2024

(51) Int. Cl. G05B 19/4099

(52) U.S. Cl. CPC G05B 19/4099; G05B 2219/37371; G05B 2219/45031

(57) ABSTRACT

Embodiments disclosed herein include a method for optimizing zones in a fluid flow system. In an embodiment, the method comprises running a baseline simulation for the fluid flow system, and running a plurality of sensitivity simulations, where each sensitivity simulation perturbs a flowrate through one of a plurality of pitch circles in the fluid flow system by an offset percentage. In an embodiment, the method further comprises generating a sensitivity matrix from the plurality of sensitivity simulations, and optimizing an objective function to enable grouping of the plurality of pitch circles into a plurality of zones.

### BACKGROUND

### 1) Field

Embodiments relate to the field of semiconductor manufacturing and, in particular, apparatuses and methods for simulating fluid flow systems and/or thermal systems to enable zone control optimization.

### 2) Description of Related Art

In semiconductor fabrication environments, the control of the flow of fluids (e.g., gasses) is an important factor in order to provide process uniformity on the surface of the wafer. Typically, the flow of gasses into a chamber is implemented through a showerhead that includes a plurality of holes. The holes can be grouped into zones for easier control. However, the determination of which holes to provide in each zone is not a simple task. This is due, at least in part, to cross-talk between the gas that flows through each hole in the showerhead. That is, changing the gas flow in one hole can also impact process uniformity directly below the hole and in areas that are adjacent to the hole. In addition to controlling the flow of fluids, thermal control can also be grouped into zones. These thermal zones also include cross-talk concerns that makes delineation of thermal zones difficult.

Existing solutions to flow control systems require physical models and extensive design of experiment (DoE) and other testing. This is an expensive and time consuming process, especially when the physical models are needed for many different processing tools within a semiconductor fabrication facility.

### SUMMARY

Embodiments disclosed herein include a method for optimizing zones in a fluid flow system. In an embodiment, the method comprises running a baseline simulation for the fluid flow system, and running a plurality of sensitivity simulations, where each sensitivity simulation perturbs a flowrate through one of a plurality of pitch circles in the fluid flow system by an offset percentage. In an embodiment, the method further comprises generating a sensitivity matrix from the plurality of sensitivity simulations, and optimizing an objective function to enable grouping of the plurality of pitch circles into a plurality of zones.

Embodiments disclosed herein include a method for optimizing zones in a thermal control plate. In an embodiment, the method comprises running a baseline simulation for the thermal control plate, and running a plurality of sensitivity simulations, where each sensitivity simulation perturbs an energy input for one of a plurality of heating elements in the thermal control plate by an offset percentage. In an embodiment, the method may further comprise generating a sensitivity matrix from the plurality of sensitivity simulations, and optimizing an objective function to enable grouping of the heating elements into a plurality of zones.

Embodiments may also comprise a method for optimizing zone grouping in a system with a plurality of inputs. In an embodiment, the method comprises running a baseline simulation for the system, where the baseline simulation comprises applying a uniform stimulus to each of the inputs. In an embodiment, the method further comprises running a plurality of sensitivity simulations, where each sensitivity simulation perturbs a stimulus to one of the plurality of inputs in the system by an offset percentage. In an embodiment, the method may further comprise generating a sensitivity matrix from the plurality of sensitivity simulations, and optimizing an objective function to enable grouping of the plurality of inputs into a plurality of zones.

### BRIEF DESCRIPTION OF THE DRAWINGS

FIG. 1 is a plan view illustration of a showerhead with holes arranged in a plurality of pitch circles, in accordance with an embodiment.

FIG. 2 is a cross-sectional illustration of a semiconductor processing tool that includes a showerhead similar to the showerhead illustrated in FIG. 1, in accordance with an embodiment.

FIGS. 3A-3D are graphs that depict a processing outcome on a wafer when different pitch circles are used in order to illustrate an effect of cross-talk in the system, in accordance with an embodiment.

FIG. 4 is a process flow diagram depicting a process for optimizing zone grouping in a showerhead using a model based approach, in accordance with an embodiment.

FIG. 5 is a graph that illustrates improvements in process uniformity when zone grouping is properly optimized, in accordance with an embodiment.

FIG. 6 is a plan view illustration of a heating plate with a plurality of resistive heating elements, in accordance with an embodiment.

FIG. 7 is a cross-sectional illustration of a semiconductor processing tool that includes a heating plate similar to the heating plate illustrated in FIG. 6, in accordance with an embodiment.

FIG. 8 is a process flow diagram depicting a process for optimizing zone grouping in a heating plate using a model based approach, in accordance with an embodiment.

FIG. 9 is a process flow diagram depicting a process for optimizing zone grouping in a system with inputs that exhibit cross-talk behavior, in accordance with an embodiment.

FIG. 10 illustrates a block diagram of an exemplary computer system that may be used in conjunction with a processing tool, in accordance with an embodiment.

### DETAILED DESCRIPTION

Systems described herein include systems and methods for simulating fluid flow systems and/or thermal systems to enable zone control optimization. In the following description, numerous specific details are set forth in order to provide a thorough understanding of embodiments. It will be apparent to one skilled in the art that embodiments may be practiced without these specific details. In other instances, well-known aspects are not described in detail in order to not unnecessarily obscure embodiments. Furthermore, it is to be understood that the various embodiments shown in the accompanying drawings are illustrative representations and are not necessarily drawn to scale.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

The embodiments illustrated and discussed in relation to the figures included herein are provided for the purpose of explaining some of the basic principles of the disclosure. However, the scope of this disclosure covers all related, potential, and/or possible, embodiments, even those differing from the idealized and/or illustrative examples presented. This disclosure covers even those embodiments which incorporate and/or utilize modern, future, and/or as of the time of this writing unknown, components, devices, systems, etc., as replacements for the functionally equivalent, analogous, and/or similar, components, devices, systems, etc., used in the embodiments illustrated and/or discussed herein for the purpose of explanation, illustration, and example.

As noted above, cross-talk between zones in a fluid or thermal system makes process uniformity difficult to control. For example, changing the gas flow in one zone of a showerhead can also impact process uniformity in other adjacent zones. That is to say, improperly grouping together inputs to the system may result in a system that is more difficult to tune in order to achieve the desired process uniformity.

Accordingly, embodiments disclosed herein may be directed to a model based approach for zone optimization in a system with multiple inputs that suffer from cross-talk. The use of a model based approach has significant advantages over existing solutions. One advantage is that there is no need to fabricate a physical model. This can be a time saving and expense saving benefit of embodiments disclosed herein. Another advantage is that the model can be run without extensive experimentation on real processing tools. This reduces research and development costs and frees up tools for revenue generating tasks. The model based optimization approach described herein is also applicable to many types of tools, chambers, and/or environments. As such, the benefits of embodiments disclosed herein can be applied throughout a semiconductor fabrication facility (or any other manufacturing environment).

In the case of a showerhead, each pitch circle may be an input that comprises a plurality of holes. Since the diameter of the pitch circles are non-uniform, the number of holes in each pitch circle may be non-uniform as well. For example, outer pitch circles will have more holes than inner pitch circles. In the case of a heating plate, each input may be a resistive heater. The resistive heater may be a conductive trace that has a ring shaped path, though other resistive heater layouts may also be used. The diameter of each resistive heaters may be non-uniform as well.

The process modeling in accordance with embodiments of the present disclosure begins with the generation of a model. The model may be a digital representation of the physical structure of the system (e.g., showerhead, heating plate, etc.) that is compatible with simulation software in order to predict processing outcomes (e.g., material deposition rates, etch rates, elemental concentrations, temperatures, etc.) on a substrate (such as a wafer). The model is used to generate a baseline simulation.

In the case of a showerhead, the baseline simulation may include flowing a gas through the holes of the showerhead with a uniform flowrate through each of the holes. After the baseline simulation, a plurality of sensitivity simulations are run on the model. Each sensitivity simulation perturbs the gas flow rate of one pitch circle of the showerhead at a time in order to determine a sensitivity of the system. A sensitivity matrix is generated from the sensitivity simulation data. The sensitivity matrix can be integrated into an objective function that is optimized in order to properly group the pitch circles into a plurality of zones.

In the case of a heating plate, the baseline simulation may include applying a uniform energy input to each resistive heater. After the baseline simulation, a plurality of sensitivity simulations are run on the model. Each sensitivity simulation perturbs the energy input to one of the resistive heaters at a time in order to determine a sensitivity of the system. A sensitivity matrix is generated from the sensitivity simulation data. The sensitivity matrix can be integrated into an objective function that is optimized in order to properly group the resistive heaters into a plurality of zones.

While embodiments disclosed here explicitly describe a showerhead embodiment and a heating plate embodiments, other embodiments are not limited. It is to be appreciated that modeling processes such as those described in greater detail herein can be applicable to many different systems that include the flow of fluids, heat transfer, or any other similarly behaving property that suffers from cross-talk between inputs.

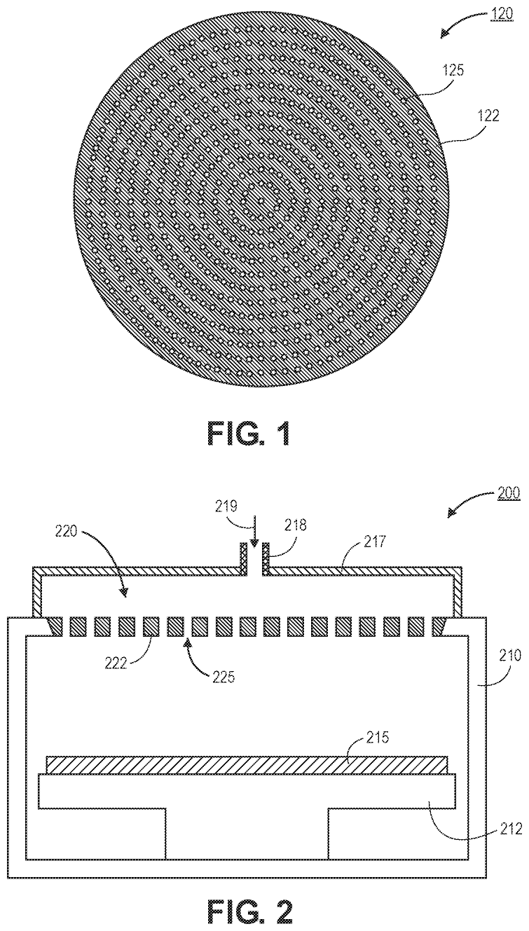

Referring now to FIG. 1, a plan view illustration of a showerhead 120 is shown, in accordance with an embodiment. The showerhead 120 may be used in order to distribute gas into a chamber, such as a plasma chamber. The showerhead 120 may include a substrate 122 with a plurality of holes 125 that pass through the substrate 122. In the embodiment shown in FIG. 1, the holes 125 are vertical holes that pass through an entire thickness of the substrate 122. Though, in other embodiments gas flow paths may include horizontal portions, baffles, or other flow control features or structures in order to distribute the gas from the top of the showerhead 120, through the showerhead 120, and out the bottom of the showerhead 120.

While shown as a single monolithic substrate 122, other embodiments may include a showerhead 120 with multiple sub-components that are coupled together to form a larger substrate 122. The substrate 122 may comprise any suitable material or materials. For example, the substrate 122 may comprise aluminum, titanium, ceramics, or the like. In other embodiments, a substrate 122 may have an exterior coating to protect the showerhead 120 from a plasma environment on the bottom side of the showerhead 120.

In an embodiment, the holes 125 may be substantially uniform to each other. That is, each of the holes 125 may have substantially the same diameter. Though, in other embodiments non-uniform diameter holes 125 may also be used. In an embodiment, the holes 125 may be arranged in a plurality of groups. For example, each group in FIG. 1 may include a ring of holes 125. Each ring of holes 125 may be referred to herein as a “pitch circle”. For example, in FIG. 1 there are twelve pitch circles (and a single hole 125 at the center of the showerhead 120) in order to provide 13 unique groups of holes 125. Though, any number of pitch circles may be provided on the showerhead 120. The pitch circles may be substantially concentric with each other.

The diameters of the pitch circles may increase in a regular pattern (i.e., at a regular pitch). For example, for a 300 mm substrate a suitable pitch between the pitch circles may be approximately 10 mm or greater. In other embodiments, the spacing between pitch circles may not be uniform. For example, the spacing between pitch circles towards a center of the showerhead 120 may be smaller than a spacing between pitch circles towards an outer edge of the showerhead 120.

In an embodiment, a first spacing between adjacent holes 125 in a first pitch circle may be substantially similar to a second spacing between adjacent holes 125 in a second pitch circle that is larger than the first pitch circle. Since the second pitch circle has a larger circumference, there may be more holes 125 in the larger second pitch circle compared to the first pitch circle. Accordingly, when each pitch circle is provided a uniform flow of gas, the flowrate through individual holes may be non-uniform. In the case of the first pitch circle and the second pitch circle described above, the holes 125 in the first pitch circle may have a higher flowrate than the holes 125 in the second pitch circle since there are more holes 125 in the second pitch circle.

In some embodiments, the showerhead 120 is configured to allow for uniform gas flow to each of the pitch circles. In other embodiments, the showerhead 120 is configured to allow for non-uniform gas flow to each of the pitch circles. The ability to provide non-uniform gas flows enables greater control of process uniformity. Additionally, non-uniform gas flows can be leveraged in order to initiate sensitivity modeling that can be used for zone grouping optimization, as will be described in greater detail below.

Referring now to FIG. 2, a cross-sectional illustration of a tool 200 is shown, in accordance with an embodiment. The tool 200 may be a semiconductor processing tool, such as, but not limited to, an etching tool, a deposition tool, an annealing tool, or the like. In an embodiment, the tool 200 may comprise a chamber 210. The chamber 210 may be sealed by a lid that comprises a showerhead 220. The showerhead 220 may be similar to the showerhead 120 described in greater detail above. For example, the showerhead 220 may comprise a substrate 222 with holes 225 that pass through a thickness of the substrate 222. The holes 225 may be arranged in circular rings, such as a plurality of pitch circles.

The gas may be confined around an upper side of the showerhead 220 by an enclosure 217 or the like. The enclosure 217 may include baffles, or other flow obstructing components in order to direct and/or control gas flow directed to one or more of the pitch circles. A gas inlet 218 may feed gas 219 into the enclosure 217. The gas 219 may flow through the showerhead 220 into an interior of the chamber 210. In an embodiment, the gas within the chamber 210 may be ionized or the like in order to form a plasma within the chamber 210. Bias electrodes (not shown) may be used to initiate and maintain the plasma in some embodiments.

In an embodiment, a pedestal 212 may be provided below the showerhead 220. The pedestal 212 may comprise an electrostatic chuck (ESC) or other structure to secure a substrate 215 to the pedestal 212. The substrate 215 may be a wafer, such as a silicon wafer, or any other substrate suitable for processing in the chamber 210. The substrate 215 may have any form factor, such as a 300 mm wafer, a 450 mm wafer, or a wafer with a smaller or larger diameter.

In an embodiment, the control of gas flow through the showerhead 220 can be used to improve process result uniformity across the surface of the substrate 215. Process uniformity can refer to the ability to have a measureable outcome that is substantially the same across the surface of the substrate. For example, a measurement of a parameter at a center of the substrate 215 may be similar to a measurement of the same parameter proximate to an edge of the substrate 215. Process uniformity may apply to many different parameters. For example, it may be desirable to control etch rate, deposition rate, elemental composition and/or concentration, layer thickness, etch profile uniformity, temperatures, and/or the like with high process uniformity across the substrate 215.

In some embodiments, the pitch circles of the showerhead are grouped into a plurality of zones. That is, two or more adjacent pitch circles may be controlled together as a single zone. This allows for easier control (since it reduces the number of controllers that are need) and can simplify the design of the gas distribution assembly (e.g., within the enclosure 217) since every pitch circle does not need to be independently controlled.

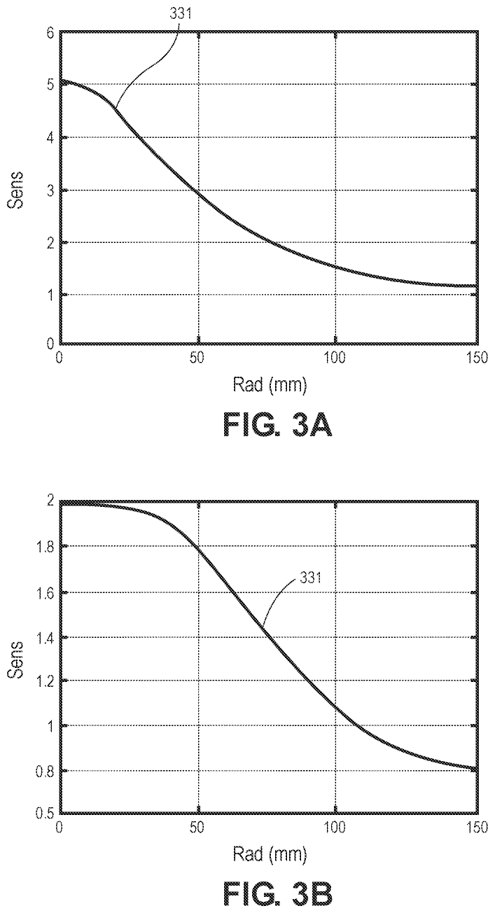

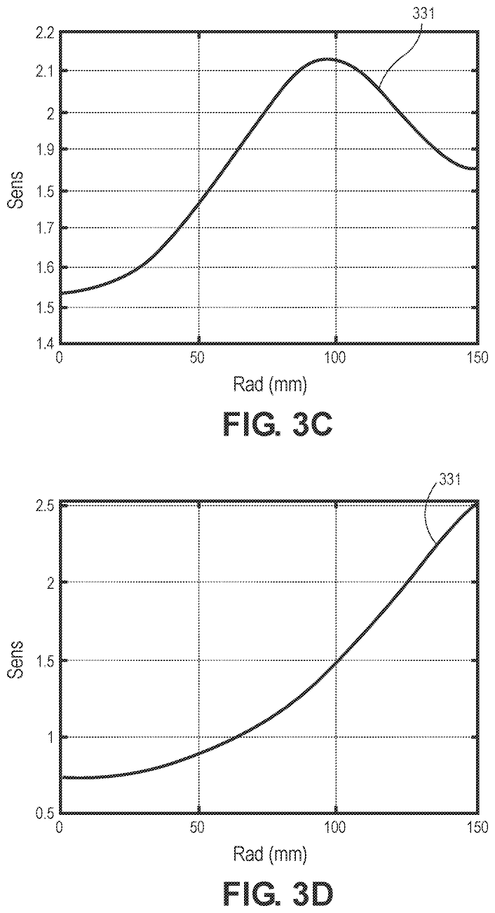

However, due to cross-talk between different pitch circles, optimizing the zone grouping is not straight forward. For example, even though the smallest diameter pitch circle is proximate to the center of the substrate 215, the flow rate through the smallest pitch circle will still have an effect on the processing conditions and outcome proximate to the edge of the substrate 215. Examples of these interrelated effects are shown in FIGS. 3A-3D.

Referring now to FIGS. 3A-3D, the graphs indicate the concentration (Y-axis) of a particular element (i.e., sensitivity) on the substrate at an increasing radius from the center of the substrate (X-axis). Though, the Y-axis may represent any measureable value, depending on the particular application. For example, the Y-axis may also represent an etch rate, a deposition rate, a temperature, or the like. Each graph indicates the effect of flowing the same amount of gas through a single pitch circle. For example, FIG. 3A is a line 331 showing the effect when the first (innermost) pitch circle is used in isolation. As shown, the effect is highest at the center of the substrate (at 0 mm) and tapers off towards the edge of the substrate (at 300 mm). FIG. 3B is the effect when a first intermediate pitch circle is used in isolation. As shown, the effect is high until about 50 mm and then decreases towards the edge of the substrate (at 150 mm). FIG. 3C is the effect with a second intermediate pitch circle (that has a larger diameter than the first intermediate pitch circle). As shown, a peak in sensitivity is provided around 100 mm and decreases towards the center (at 0 mm) and towards the edge of the substrate (at 150 mm). Finally, FIG. 3D is the effect with a pitch circle proximate to an edge of the substrate (at 150 mm). As shown, the effect at the edge of the substrate (at 150 mm) is highest, and the effect tapers down towards the center (at 0 mm).

As illustrated in the graphs in FIGS. 3A-3D, each pitch circle contributes to the sensitivity of the substrate across the entire surface. Stated differently, there is not a one-to-one relationship with the effect location and the positioning of the pitch circle. Accordingly, embodiments disclosed herein utilize a form of matrix based computation in order to account for the various effects of each pitch circle across the surface of the substrate in order to optimize the proper zone grouping of the pitch circles.

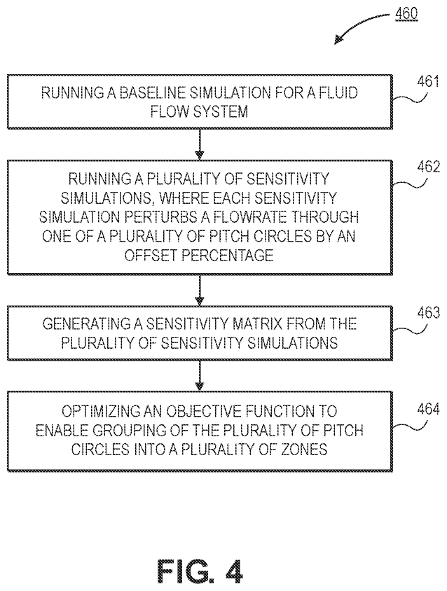

Referring now to FIG. 4, a process flow diagram of a process 460 for optimizing zone grouping in a fluid flow system is shown, in accordance with an embodiment. In an embodiment, the fluid flow system may be any type of component with multiple inputs through which a fluid flows. The process 460 may be used to group the inputs into zones in order to optimize control of a process. For example, the fluid flow system may include a showerhead similar to showerhead 120 described herein. The inputs of the showerhead may be the plurality of pitch circles.

In an embodiment, the process 460 may begin with operation 461, which comprises running a baseline simulation for a fluid flow system. The baseline simulation is implemented by developing a model. The model may be a digital representation of the physical structure of the system (e.g., showerhead) that is compatible with simulation software in order to predict processing outcomes (e.g., material deposition rates, etch rates, elemental concentrations, temperatures, etc.) on a substrate. In an embodiment, the model includes a plurality of holes through which the fluid (e.g., gas) flows. The holes may be arranged in a plurality of pitch circles in some embodiments. There may be between five and thirty pitch circles in some embodiments. Though, a lower number or a greater number of pitch circles may also be used in some instances.

After the model has been developed, the baseline simulation is implemented. The baseline simulation may include simulating a process where the flow through each hole in the system is uniform in accordance with Equation 1, where Qₕₒₗₑ is the flow rate through each hole, \dot{m}ₜₒₜₐₗ is the total flow through the system, and n_{holes total} is the total number of holes in the system. The baseline simulation also is used to generate a baseline flow through each pitch circle using Equation 2, where Q_{PC} is the flow rate through a given pitch circle and n_{holesPC} is the number of holes in the given pitch circle (PC).

$${Q}_{hole} = \frac{{\dot{m}}_{total}}{{n}_{h oles total}} \qquad ( 1 )$$

$${Q}_{P C} = {Q}_{h o l e} \times {n}_{h oles PC} \qquad ( 2 )$$

The results on the substrate are then calculated and represented by a baseline matrix y_{substrate BL}. The baseline matrix may be a single column (since there is only one baseline result), and there may be any number of rows (depending on how granular the desired data needs to be). For example, in a 300 mm wafer substrate, the 150 mm from center to edge may be expressed as 150 rows (i.e., one row for each millimeter from center to edge). Using such a construction, the baseline matrix may be a (150×1) matrix.

In an embodiment, the process 460 may continue with operation 462, which comprises running a plurality of sensitivity simulations. In an embodiment, each sensitivity simulation perturbs a flowrate through one of the plurality of pitch circles by an offset percentage. For example, if there are twelve pitch circles, there will be twelve sensitivity simulations. In each sensitivity simulation, the flowrate in one of the pitch circles will be perturbed, and the remaining pitch circles will maintain the baseline flow rate. The offset percentage may be any desired offset amount (either positive or negative). For example, the offset percentage may be up to 1%, up to 5%, up to 10%, or up to 20% (all of which may be either a positive or negative percentage). In an embodiment, the flowrate through the perturbed pitch circle Q_{PC} may be defined by Equation 3, where P is the offset percentage. The results on the substrate are then calculated and represented by a perturbation matrix y_{substrate PC}. The perturbation matrix may have a form of (150×C) where C is the number of pitch circles in the system.

$${Q}_{P C} = ( {Q}_{h o l e} \times {n}_{h oles PC} ) + P ( {Q}_{h o l e} \times {n}_{h oles PC} ) \qquad ( 3 )$$

In an embodiment, the process 460 may continue with operation 463, which comprises generating a sensitivity matrix S from the plurality of sensitivity simulations. The sensitivity matrix S may be generated through the use of Equation 4. S may have the same form (e.g., (150×C)) as the perturbation matrix y_{substrate PC}.

$$S = \frac{Δ y}{Δ F} = \frac{( {y}_{substratePC} - {y}_{substrate BL} )}{P} \qquad ( 4 )$$

In an embodiment, the process 460 may continue with operation 464, which comprises optimizing an objective function to enable grouping of the plurality of pitch circles into a plurality of zones. The objective function y_{substrate OPT} is represented in Equation 5. The objective function is minimized by solving for dF for each column of the objective function matrix (i.e., for each pitch circle). In an embodiment, y_{substrate OPT} may refer to a mean value or a value based on experimental analysis if the model has been calibrated with experimental data.

$${y}_{substrate OPT} = {y}_{substrate BL} + ( S ) d F \qquad ( 5 )$$

The solved dF values for each pitch circle can then be used in order to optimize the zone assignment for the pitch circles. For example, pitch circles with comparable dF values can be grouped into a zone together. In one embodiment, a clustering algorithm can be used in order to group the pitch circles into any desired number of zones based on the calculated dF values. Suitable clustering algorithms may include, but are not limited to centroid based or partition clustering, hierarchical based clustering, distribution based clustering, or density based clustering. Depending on the results of the optimization, each zone may include different numbers of pitch circles.

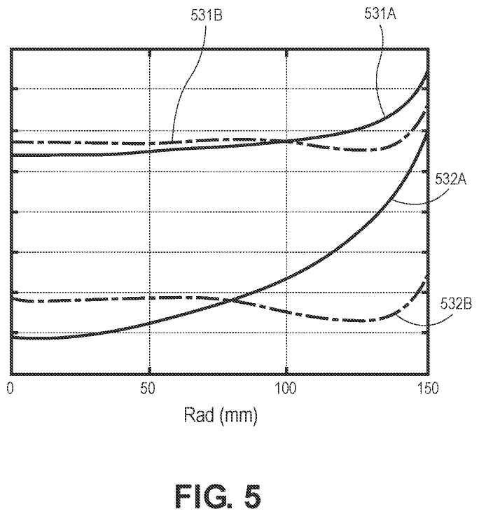

Referring now to FIG. 5, a process uniformity graph with a concentration on the Y-axis and distance from the center of the substrate on the X-axis is shown, in accordance with an embodiment. The lines 531 depict the difference between the baseline result and the optimized result when a 3-zone optimization process similar to process 460 is used. Line 531A is the baseline case and line 531B is the optimized case. As shown, the optimized line 531B illustrates a more uniform process outcome. The lines 532 depict the difference between the baseline result and the optimized result when a 4-zone optimization process similar to process 460 is used. Line 532A is the baseline case and line 532B is the optimized case. As shown, the optimized line 532B illustrates a more uniform process outcome.

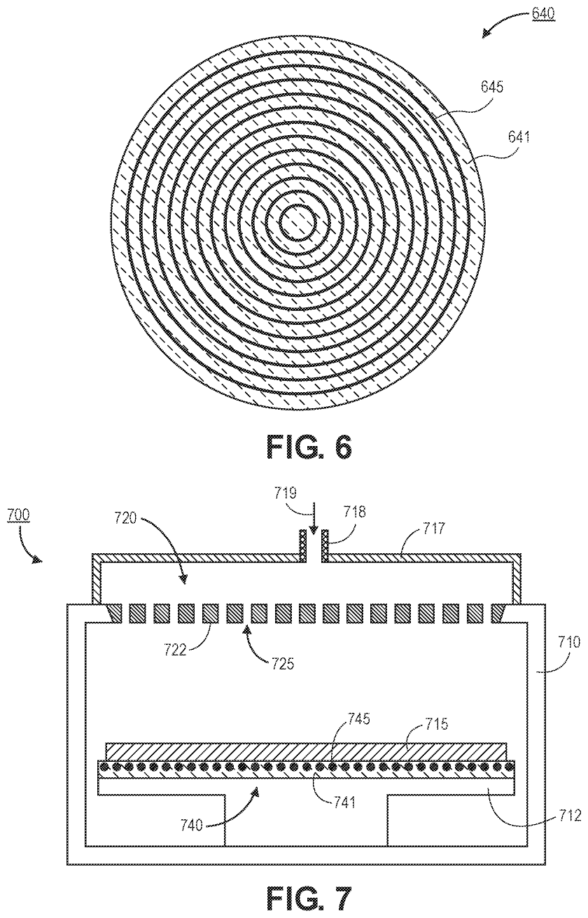

In addition to being applicable to fluid flow systems (e.g., flow of gasses and liquids), embodiments disclosed herein may also be applicable to heat transfer application. For example, a heating plate for a chuck or a lamp array for a thermal annealing system may benefit from optimized zone groupings. An example of a heating plate configuration is shown in FIG. 6.

Referring now to FIG. 6, a plan view illustration of a heating plate 640 is shown, in accordance with an embodiment. In an embodiment, the heating plate 640 may include a substrate 641. The substrate 641 may include a ceramic or the like. A plurality of heating elements 645 may be provided within the substrate 641. For example, the heating elements 645 may be embedded within the substrate 641 in some embodiments. The heating elements 645 may be electrically conductive traces that generate heat through resistive heating as electrical current passes through the heating elements. In an embodiment, the heating elements 645 may be circular rings. The rings may be concentric in some embodiments. Each heating element 645 may have a different diameter. While concentric ring heating elements 645 are shown, embodiments are not limited to such a heating element layout. For example, serpentine traces, spiral traces, and/or the like may be used in other embodiments. The heating elements 645 may also comprise fluidic channels for flowing a heating and/or cooling thermal fluid.

Referring now to FIG. 7, a cross-sectional illustration of a tool 700 is shown, in accordance with an embodiment. The tool 700 may be a semiconductor processing tool, such as, but not limited to, an etching tool, a deposition tool, an annealing tool, or the like. In an embodiment, the tool 700 may comprise a chamber 710. The chamber 710 may be sealed by a lid that comprises a showerhead 720. The showerhead 720 may be similar to the showerhead 120 described in greater detail above. For example, the showerhead 720 may comprise a substrate 722 with holes 725 that pass through a thickness of the substrate 722. The holes 725 may be arranged in circular rings, such as a plurality of pitch circles.

The gas may be confined around an upper side of the showerhead 720 by an enclosure 717 or the like. The enclosure 717 may include baffles, or other flow obstructing components in order to direct and/or control gas flow directed to one or more of the pitch circles. A gas inlet 718 may feed gas 719 into the enclosure 717. The gas 719 may flow through the showerhead 720 into an interior of the chamber 710. In an embodiment, the gas within the chamber 710 may be ionized or the like in order to form a plasma within the chamber 710. Bias electrodes (not shown) may be used to initiate and maintain the plasma in some embodiments.

In an embodiment, a pedestal 712 may be provided below the showerhead 720. The pedestal 712 may comprise an ESC or other structure to secure a substrate 715 to the pedestal 712. In an embodiment, a heating plate 740 may be provided on the pedestal 712. While shown as distinct components, other embodiments may include a pedestal 712 with an integrated heating plate 740. The heating plate 740 may be similar to the heating plate 640 described in greater detail above. For example, the heating plate 740 may comprise a substrate 741 with a plurality of embedded heating elements 745. The substrate 715 may be a wafer, such as a silicon wafer, or any other substrate suitable for processing in the chamber 710. The substrate 715 may have any form factor, such as a 300 mm wafer, a 450 mm wafer, or a wafer with a smaller or larger diameter.

In an embodiment, the control of heat transfer across the surface of the substrate 715 by the heating plate 740 may improve process result uniformity across the surface of the substrate 715. Process uniformity can refer to the ability to have a measureable outcome that is substantially the same across the surface of the substrate. For example, a measurement of a parameter at a center of the substrate 715 may be similar to a measurement of the same parameter proximate to an edge of the substrate 715. Process uniformity may apply to many different parameters. For example, it may be desirable to control etch rate, deposition rate, elemental composition and/or concentration, layer thickness, etch profile uniformity, temperatures, and/or the like with high process uniformity across the substrate 715.

In some embodiments, the heating elements 745 of the heating plate 740 are grouped into a plurality of zones. That is, two or more adjacent heating elements 745 may be controlled together as a single zone. This allows for easier control (since it reduces the number of variables that need to be controlled) and can simplify the design of the heating plate 740 since every heating element 745 does not need to be independently controlled.

However, due to cross-talk between different heating elements 745, optimizing the zone grouping is not straight forward. For example, even though the smallest diameter heating element 745 is proximate to the center of the substrate 715, the flow rate through the smallest heating element will still have an effect on the processing conditions and outcome proximate to the edge of the substrate 715. Examples of these interrelated effects are similar to those shown in FIGS. 3A-3D with respect to fluid flow control described in greater detail above.

Accordingly, embodiments disclosed herein utilize a form of matrix based computation in order to account for the various effects of each heating element 745 across the surface of the substrate 715 in order to optimize the proper zone grouping of the heating elements 745.

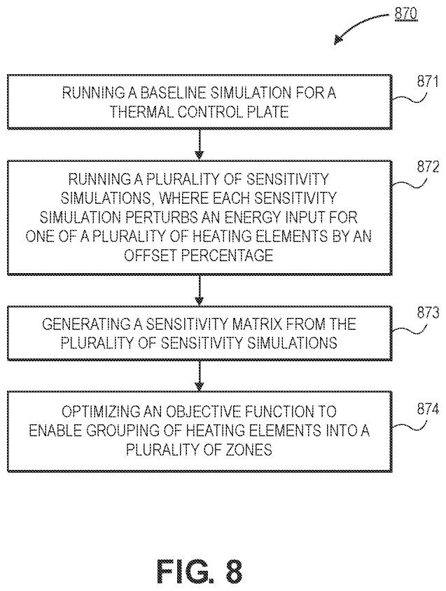

Referring now to FIG. 8, a process flow diagram of a process 870 for optimizing zone grouping in a thermal system is shown, in accordance with an embodiment. In an embodiment, the thermal system may be any type of component with multiple inputs configured to generate heat (e.g., a heating plate), remove heat (e.g., a cooling plate), or both generate and remove heat. The process 870 may be used to group the inputs into zones in order to optimize control of a process. For example, the thermal system may include a heating plate similar to heating plate 640 described herein. The inputs of the heating plate may be the plurality of heating elements.

In an embodiment, the process 870 may begin with operation 871, which comprises running a baseline simulation for a thermal control plate. The baseline simulation is implemented by developing a model. The model may be a digital representation of the physical structure of the system (e.g., thermal control plate) that is compatible with simulation software in order to predict processing outcomes (e.g., material deposition rates, etch rates, elemental concentrations, temperatures, etc.) on a substrate. In an embodiment, the model includes a plurality of heating elements. The heating elements may be arranged in a plurality of concentric rings in some embodiments. There may be between five and thirty rings in some embodiments. Though, a lower number or a greater number of rings may also be used in some instances.

After the model has been developed, the baseline simulation is implemented. The baseline simulation may include simulating a process where the energy input per unit length of the trace for each heating element in the system is uniform. Accordingly, a larger heating element will produce more total heat than a smaller heating element since more energy will be inputted into the larger heating element to account for the larger circumference of the heating element compared to the smaller heating element.

The results on the substrate are then calculated and represented by a baseline matrix y_{substrate BL}. The baseline matrix may be a single column (since there is only one baseline result), and there may be any number of rows (depending on how granular the desired data needs to be). For example, in a 300 mm wafer substrate, the 150 mm from center to edge may be expressed as 150 rows (i.e., one row for each millimeter from center to edge). Using such a construction, the baseline matrix may be a (150×1) matrix.

In an embodiment, the process 870 may continue with operation 872, which comprises running a plurality of sensitivity simulations. In an embodiment, each sensitivity simulation perturbs an energy input for one of the plurality of heating elements by an offset percentage. For example, if there are twelve heating elements, there will be twelve sensitivity simulations. In each sensitivity simulation, the energy input to one of the heating elements will be perturbed, and the remaining heating elements will maintain the baseline energy input. The offset percentage may be any desired offset amount (either positive or negative). For example, the offset percentage may be up to 1%, up to 5%, up to 10%, or up to 20% (all of which may be either a positive or negative percentage). The results on the substrate are then calculated and represented by a perturbation matrix y_{substrate HE}. The perturbation matrix will have a form of (150×C) where C is the number of pitch circles in the system.

In an embodiment, the process 870 may continue with operation 873, which comprises generating a sensitivity matrix S from the plurality of sensitivity simulations. The sensitivity matrix S may be generated using processes and equations similar to Equation 4. S may have the same form (e.g., (150×C)) as the perturbation matrix y_{substrate PC} described above.

In an embodiment, the process 870 may continue with operation 874, which comprises optimizing an objective function to enable grouping of the plurality of heating elements into a plurality of zones. The objective function y_{substrate OPT} is represented in Equation 6. The objective function is minimized by solving for dF for each column of the objective function matrix (i.e., for each heating element).

$${y}_{substrate OPT} = {y}_{substrate BL} + ( S ) d F \qquad ( 6 )$$

The solved dF values for each heating element can then be used in order to optimize the zone assignment for the heating elements. For example, heating elements with comparable dF values can be grouped into a zone together. In one embodiment, a clustering algorithm can be used in order to group the heating elements into any desired number of zones based on the calculated dF values. Suitable clustering algorithms may include, but are not limited to centroid based or partition clustering, hierarchical based clustering, distribution based clustering, or density based clustering. Depending on the results of the optimization, each zone may include different numbers of heating elements.

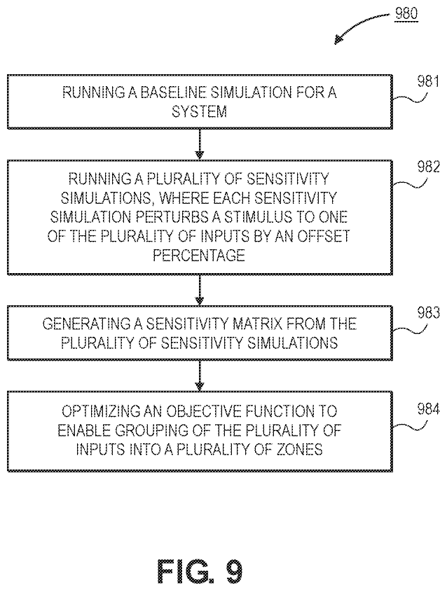

In the embodiments described in greater detail above, a fluid flow system and a thermal system are optimized. However, it is to be appreciated that any system with a plurality of inputs that have cross-communication between the inputs may benefit from embodiments disclosed herein. FIG. 9 is a generic representation of a process for model based zone grouping optimization that may be applicable to other applications and systems.

Referring now to FIG. 9, a process flow diagram of a process 980 for optimizing zone grouping in a system is shown, in accordance with an embodiment. In an embodiment, the system may be any type of component with multiple inputs that are prone to cross-talk, similar to what is described in FIGS. 3A-3D above. The process 980 may be used to group the inputs into zones in order to optimize control of a process. The inputs may refer to the holes for enabling fluid flow, heating elements for generating heat, coolant loops for removing heat, lamps for generating heat, or the like.

In an embodiment, the process 980 may begin with operation 981, which comprises running a baseline simulation for the system. The baseline simulation is implemented by developing a model. The model that is generated may be a digital model with functionality similar to other models disclosed herein. There may be between five and thirty inputs in some embodiments. Though, a lower number or a greater number of inputs may also be used in some instances.

After the model has been developed, the baseline simulation is implemented. The baseline simulation may include simulating a process where a stimulus to each input is uniform across the system. For example, the stimulus may refer to a flow rate of a fluid, an electrical power, a coolant pulse duration, or the like. The results on the substrate are then calculated and represented by a baseline matrix y_{substrate BL}. The baseline matrix may be similar to other baseline matrices described in greater detail herein.

In an embodiment, the process 980 may continue with operation 982, which comprises running a plurality of sensitivity simulations. In an embodiment, each sensitivity simulation perturbs a stimulus to one of the inputs by an offset percentage. For example, if there are twelve inputs, there will be twelve sensitivity simulations. In each sensitivity simulation, the stimulus to one of the inputs will be perturbed, and the remaining inputs will maintain the baseline stimulus. The offset percentage may be any desired offset amount (either positive or negative). For example, the offset percentage may be up to 1%, up to 5%, up to 10%, or up to 20% (all of which may be either a positive or negative percentage). The results on the substrate are then calculated and represented by a perturbation matrix. The perturbation matrix may be similar to other perturbation matrices described in greater detail herein.

In an embodiment, the process 980 may continue with operation 983, which comprises generating a sensitivity matrix from the plurality of sensitivity simulations. The sensitivity matrix may be generated and/or calculated through equations and/or processes similar to any of the other sensitivity matrices described in greater detail herein.

In an embodiment, the process 980 may continue with operation 984, which comprises optimizing an objective function to enable grouping of the plurality of inputs into a plurality of zones. The objective function is minimized by solving for dF for each column of the objective function matrix (i.e., for each input). The objective function may be similar to any of the objective functions described in greater detail herein.

The solved dF values for each input can then be used in order to optimize the zone assignment for the heating elements. For example, inputs with comparable dF values can be grouped into a zone together with a clustering algorithm or the like. Depending on the results of the optimization, each zone may include different numbers of inputs.

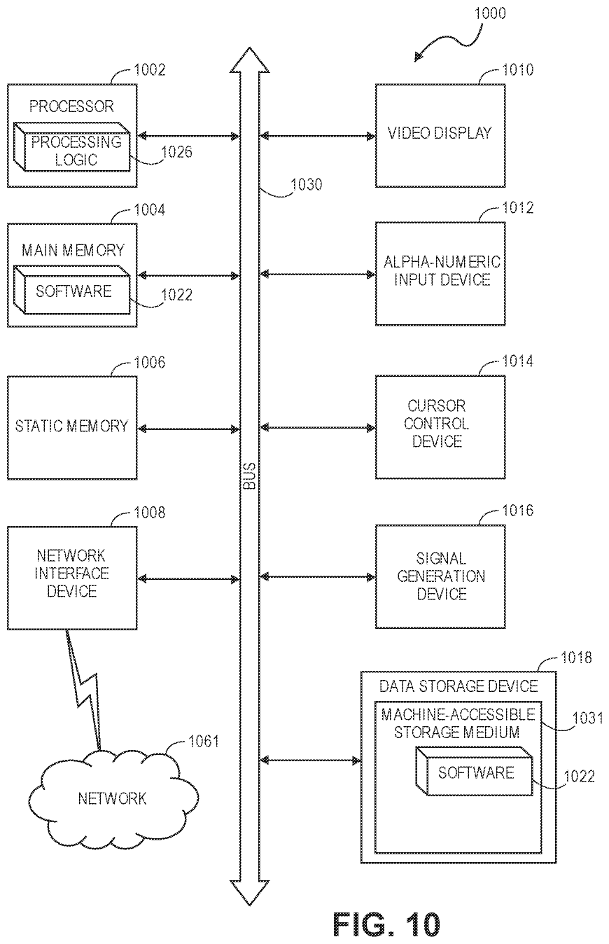

Referring now to FIG. 10, a block diagram of an exemplary computer system 1000 of a processing tool is illustrated in accordance with an embodiment. In an embodiment, computer system 1000 is coupled to and controls processing in the processing tool. Computer system 1000 may be connected (e.g., networked) to other machines in a Local Area Network (LAN), an intranet, an extranet, or the Internet. Computer system 1000 may operate in the capacity of a server or a client machine in a client-server network environment, or as a peer machine in a peer-to-peer (or distributed) network environment. Computer system 1000 may be a personal computer, a tablet personal computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 1000, the term “machine” shall also be taken to include any collection of machines (e.g., computers) that individually or jointly execute a set (or multiple sets) of instructions to perform any one or more of the methodologies described herein.

Computer system 1000 may include a computer program product, or software 1022, having a non-transitory machine-readable medium having stored thereon instructions, which may be used to program computer system 1000 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 1000 includes a system processor 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a secondary memory 1018 (e.g., a data storage device), which communicate with each other via a bus 1030.

System processor 1002 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 1002 may also be one or more special-purpose processing devices such as an application specific integrated circuit (ASIC), a field programmable gate array (FPGA), a digital signal system processor (DSP), network system processor, or the like. System processor 1002 is configured to execute the processing logic 1026 for performing the operations described herein.

The computer system 1000 may further include a system network interface device 1008 for communicating with other devices or machines. The computer system 1000 may also include a video display unit 1010 (e.g., a liquid crystal display (LCD), a light emitting diode display (LED), or a cathode ray tube (CRT)), an alphanumeric input device 1012 (e.g., a keyboard), a cursor control device 1014 (e.g., a mouse), and a signal generation device 1016 (e.g., a speaker).

The secondary memory 1018 may include a machine-accessible storage medium 1031 (or more specifically a computer-readable storage medium) on which is stored one or more sets of instructions (e.g., software 1022) embodying any one or more of the methodologies or functions described herein. The software 1022 may also reside, completely or at least partially, within the main memory 1004 and/or within the system processor 1002 during execution thereof by the computer system 1000, the main memory 1004 and the system processor 1002 also constituting machine-readable storage media. The software 1022 may further be transmitted or received over a network 1061 via the system network interface device 1008. In an embodiment, the network interface device 1008 may operate using RF coupling, optical coupling, acoustic coupling, or inductive coupling.

While the machine-accessible storage medium 1031 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

In the foregoing specification, specific exemplary embodiments have been described. It will be evident that various modifications may be made thereto without departing from the scope of the following claims. The specification and drawings are, accordingly, to be regarded in an illustrative sense rather than a restrictive sense.

What is claimed is:

1. A method for optimizing zones in a fluid flow system, comprising:
running a baseline simulation for the fluid flow system;
running a plurality of sensitivity simulations, wherein each sensitivity simulation perturbs a flowrate through one of a plurality of pitch circles in the fluid flow system by an offset percentage;
generating a sensitivity matrix from the plurality of sensitivity simulations; and
optimizing an objective function to enable grouping of the plurality of pitch circles into a plurality of zones.

2. The method of claim 1, wherein the fluid flow system is a showerhead.

3. The method of claim 1, wherein the plurality of pitch circles comprises five or more pitch circles.

4. The method of claim 1, wherein the plurality of zones comprises three zones.

5. The method of claim 1, wherein the plurality of zones comprises four or more zones.

6. The method of claim 1, wherein the offset percentage is 5% or more.

7. The method of claim 1, wherein the offset percentage is a positive offset percentage or a negative offset percentage.

8. The method of claim 1, wherein a simulated flowrate through each hole in the fluid flow system is the same for all holes in the fluid flow system during the baseline simulation.

9. The method of claim 1, wherein a clustering algorithm is used to group the plurality of pitch circles into the plurality of zones.

10. The method of claim 1, wherein the fluid flow system is part of a plasma chamber.

11. A method for optimizing zones in a thermal control plate, comprising:
running a baseline simulation for the thermal control plate;
running a plurality of sensitivity simulations, wherein each sensitivity simulation perturbs an energy input for one of a plurality of heating elements in the thermal control plate by an offset percentage;
generating a sensitivity matrix from the plurality of sensitivity simulations; and
optimizing an objective function to enable grouping of the heating elements into a plurality of zones.

12. The method of claim 11, wherein the heating elements are resistive heater rings.

13. The method of claim 11, wherein the heating elements are thermal fluid channels.

14. The method of claim 11, wherein the plurality of zones comprises three or more zones.

15. The method of claim 11, wherein the offset percentage is 5% or more.

16. The method of claim 11, wherein the offset percentage is a positive offset percentage or a negative offset percentage.

17. A method for optimizing zone grouping in a system with a plurality of inputs, comprising:
running a baseline simulation for the system, wherein the baseline simulation comprises applying a uniform stimulus to each of the inputs;
running a plurality of sensitivity simulations, wherein each sensitivity simulation perturbs a stimulus to one of the plurality of inputs in the system by an offset percentage;
generating a sensitivity matrix from the plurality of sensitivity simulations; and
optimizing an objective function to enable grouping of the plurality of inputs into a plurality of zones.

18. The method of claim 17, wherein the system is a showerhead, and wherein the inputs are flowrates through holes in the showerhead.

19. The method of claim 18, wherein the system is a heater plate, and wherein the inputs are energy inputs into resistive heaters.

20. The method of claim 17, wherein the system is part of a semiconductor processing tool.
